(19) United States
(12) Patent Application Publication
(10) Pub. No.: US 2026/0122003 A1
(43) Pub. Date: Apr. 30, 2026

(54) Multicore Network Adapter

(71) Applicant: Mellanox Technologies, Ltd., Yokneam (IL)

(72) Inventors: Sharon Ulman, Kfar Yehoshua (IL); Lior Narkis, Petah Tikva (IL); Noam Bloch, Bat Shlomo (IL); Ortal Ben Moshe, Ein HaEmek (IL)

(21) Appl. No.: 18/932,660

(22) Filed: Oct. 31, 2024

(51) Int. Cl. H04L 49/101; H04L 47/125

(52) U.S. Cl. CPC H04L 49/101; H04L 47/125

(57) ABSTRACT

A network adapter includes a host interface, multiple port circuits, a plurality of network-adapter cores, and a crossbar circuit. The host interface is to communicate with one or more hosts. The multiple port circuits are to communicate with a packet network. The network-adapter cores are to serve the one or more hosts in transmitting and receiving packets over the packet network, while identifying to the one or more hosts as respective independent network adapters. The crossbar circuit is to connect the network-adapter cores to the port circuits.

### TECHNICAL FIELD

The present disclosure relates generally to network communication, and particularly to multicore network adapters.

### BACKGROUND

Computing and communication systems such as data centers and High-Performance Computing (HPC) clusters typically comprise multiple hosts that exchange large volumes of data with one another. Network adapters in such systems are thus required to operate at high bandwidth, sometimes on the order of several Terabits per second (Tbps).

### SUMMARY

A network adapter includes a host interface, multiple port circuits, a plurality of network-adapter cores, and a crossbar circuit. The host interface is to communicate with one or more hosts. The multiple port circuits are to communicate with a packet network. The network-adapter cores are to serve the one or more hosts in transmitting and receiving packets over the packet network, while identifying to the one or more hosts as respective independent network adapters. The crossbar circuit is to connect the network-adapter cores to the port circuits.

In some embodiments, a network-adapter core is to select a port circuit for transmitting a packet to the network by applying a criterion aiming to balance a traffic load among the multiple port circuits.

In some embodiments, (i) two or more of the network-adapter cores are to queue packet descriptors, of packets that are destined to a port circuit, in respective queues associated with the port circuit, and (ii) the port circuit is to pop the packet descriptors from the queues of the network-adapter cores in accordance with a scheduling criterion, and to send the corresponding packets to the packet network. Typically, the scheduling criterion aims to apply fairness among a subset of the queues of the network-adapter cores that are non-empty.

In some embodiments, a port circuit is to receive packets from the packet network and, for each packet, to determine a network-adapter core that will process the packet, and to send the packet to the determined network-adapter core. In an example embodiment, the port circuit is to determine the network-adapter core depending on a destination address specified in the packet. In a disclosed embodiment, the port circuit is to determine the network-adapter core based on a value specified in the packet header.

In some embodiments, the host interface is to communicate with the one or more hosts over a peripheral bus, and is configurable to set-up multiple links of the peripheral bus, connecting each network-adapter core to one or more of the hosts. In an example embodiment, the host interface is to assign each of the network-adapter cores one or more unique physical functions of the peripheral bus.

Typically, any of the network-adapter cores is to communicate packets with any of the port circuits, any of the port circuits is to communicate packets with any of the network-adapter cores, and the crossbar circuit is to connect any of the network-adapter cores with any of the port circuits.

There is additionally provided, in accordance with an embodiment that is described herein, a method in a network adapter that includes a host interface, multiple port circuits, a plurality of network-adapter cores and a crossbar circuit. The method includes communicating with one or more hosts using the host interface, and communicating with a packet network using the multiple port circuits. The network-adapter cores are connected to the port circuits using the crossbar circuit. The one or more hosts are served by the plurality of network-adapter cores of the network adapter in transmitting and receiving packets over the packet network, while identifying to the one or more hosts as respective independent network adapters.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a multicore Network Interface Controller (NIC), in accordance with an embodiment that is described herein;

FIGS. 2A-2E are block diagrams that schematically illustrate example topologies for connecting hosts to a multicore NIC, in accordance with embodiments that are described herein;

FIG. 3 is a block diagram that schematically illustrates packet transmission in a multicore NIC, in accordance with an embodiment that is described herein;

FIG. 4 is a flow chart that schematically illustrates a method for packet transmission in a multicore NIC, in accordance with an embodiment that is described herein;

FIG. 5 is a block diagram that schematically illustrates packet reception in a multicore NIC, in accordance with an embodiment that is described herein;

FIG. 6 is a flow chart that schematically illustrates a method for packet reception in a multicore NIC, in accordance with an embodiment that is described herein; and

FIG. 7 is a block diagram that schematically illustrates a computing system comprising multicore NICs, in accordance with an embodiment that is described herein.

### DETAILED DESCRIPTION OF EMBODIMENTS

### Overview

Embodiments that are described herein provide high-performance network adapter architectures that are scalable to reach throughputs of many Terabits per second.

In the present context, the term “network adapter” refers to any suitable device that provides network access to a host or to multiple hosts. Non-limiting examples of network adapters include Ethernet Network Interface Controllers (NICs), InfiniBand™ (IB) Host Channel Adapters (HCAs), as well as Data Processing Units (DPUs, also referred to as “smart NICs”). The embodiments described herein refer mainly to a multicore NIC comprising multiple NIC cores, for the sake of clarity, but the disclosed techniques are applicable in a similar manner to any other suitable type of network adapter.

In the disclosed embodiments, a network adapter comprises a plurality of network-adapter cores. The network adapter further comprises a configurable host interface that allows the network-adapter cores to serve one or more hosts, and a crossbar circuit that connects the network-adapter cores to multiple port circuits. Each of the network-adapter cores operates as a self-contained full-functionality network adapter. In particular, each network-adapter core identifies itself to the hosts as an independent network adapter.

As will be explained in detail below, the disclosed architecture provides a “look and feel” of multiple independent network adapters toward the hosts, while at the same time balancing the network behavior among the network-adapter cores. For example, if one or more of the ports are congested or otherwise exhibit degraded performance, the disclosed architecture ensures that the performance degradation is spread and balanced across the various network-adapter cores. As a result, a host that requires high bandwidth may readily divide the traffic among different network-adapter cores-Traffic handled by different network-adapter cores will have similar latencies.

Various mechanisms of the disclosed multicore architecture, including host interface configurations, load balancing and transmit-path and receive-path processing, are addressed.

### System Description

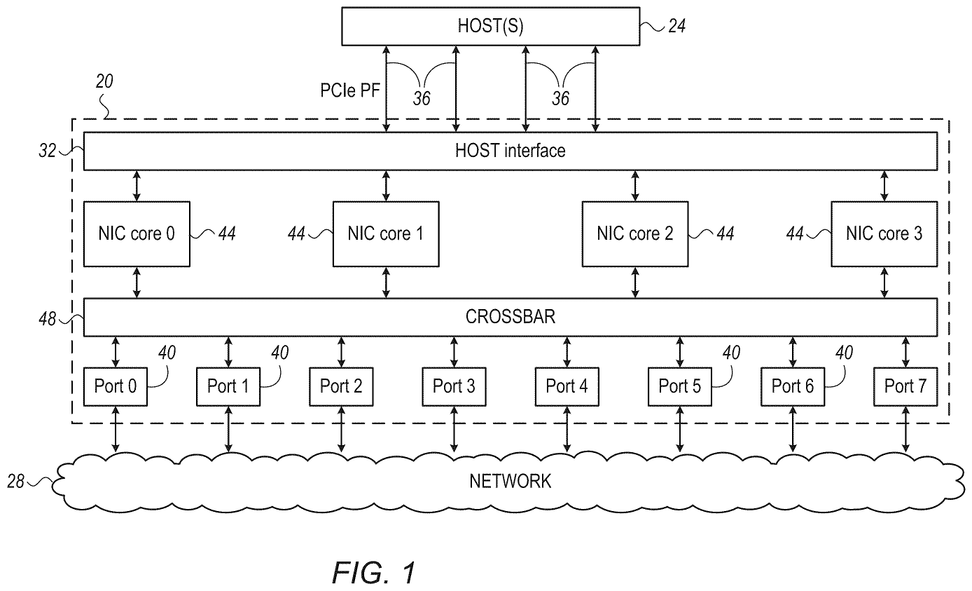

FIG. 1 is a block diagram that schematically illustrates a multicore Network Interface Controller (NIC) 20, in accordance with an embodiment that is described herein. NIC 20 serves one or more hosts 24 in transmitting and receiving packets to and from a network 28.

Hosts 24 may comprise, for example, Central Processing Units (CPUs), Graphics Processing Units (GPUs) or any other suitable host. Network 28 may comprise, for example an Ethernet network, an IB network, NVLINK network or any other suitable network type.

NIC 20 comprises a host interface 32, multiple port circuits 40 (also referred to simply as “ports” for brevity), multiple NIC cores 44, and a crossbar circuit 48.

Host interface 32 is configured for connecting the NIC to hosts 24. Host interface 32 may communicate with hosts 24 using any suitable interface or protocol. In some embodiments, host interface 32 communicates with hosts 24 over a peripheral bus such as Peripheral Component Interconnect express (PCIe), Nvlink, Ground Reference Signaling (GRS), Low Power Interconnect (LPI), Low Latency Interconnect (LLI) or Compute Express Link (CXL) bus. Alternatively, a suitable Chip-to-Chip (C2C) or Die-to-Die (D2D) interface, or any other suitable interface, can be used. In the example embodiments described herein, host interface 32 communicates with hosts 24 over a communication link 36 such as a PCIe bus comprising multiple PCIe Physical Functions (PFs), CXL, NVLINK, GRS, LPI, LLI, or any other chip-to-chip or die-to-die communication link.

Ports 40 serve as network interfaces that connect NIC 20 to network 28. NIC cores 44 perform the various packet processing tasks of NIC 20, such as, for example, Remote Direct Memory Access (RDMA) transport, Ethernet or Infiniband protocol processing, security, encryption and decryption, storage operations, packet header modifications, operations related to telemetry and congestion control, scatter/gather operations, and various others.

Crossbar 48 connects NIC cores 44 and ports 40. Crossbar 48 enables any NIC core 44 to communicate (transmit and receive) with any port 40. Typically, the operation of crossbar 48 does not involve buffering or queuing of data or metadata. Buffering or queuing is typically performed in ports 40 and in NIC cores 44. As such, the latency of crossbar 48 is minimal.

The configuration of NIC 20, as depicted in FIG. 1, is an example configuration that is chosen purely for the sake of conceptual clarity. In alternative embodiments, any other suitable configuration can be used. For example, in FIG. 1 NIC 20 comprises four NIC cores 44 (denoted “NIC CORE 0”-“NIC CORE 3”) and eight ports 40 (denoted “PORT 0”-“PORT 7”). Alternatively, NIC 20 may comprise any other suitable numbers of NIC cores and ports. Similarly, NIC 24 may serve any suitable number of hosts 24.

In an example implementation, the bandwidth of each individual NIC core 44 is 1.6 Tbps, and the total bandwidth of NIC 20 is 6.4 Tbps. Alternatively, any other suitable bandwidths s can be used.

In some embodiments, NIC 20 comprises a controller (not seen in the figures) that is responsible for general management and configuration of NIC 20 and its components. In an example embodiment, one of NIC cores 44 (e.g., “NIC CORE 0”) serves as the controller. Alternatively, a separate controller device can be used.

### Host Interface Topologies

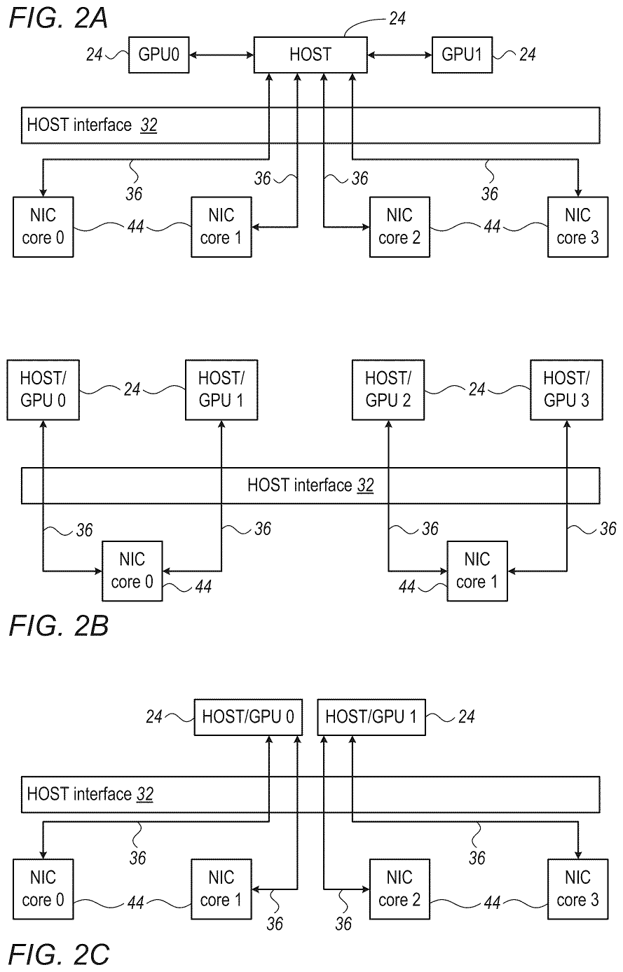

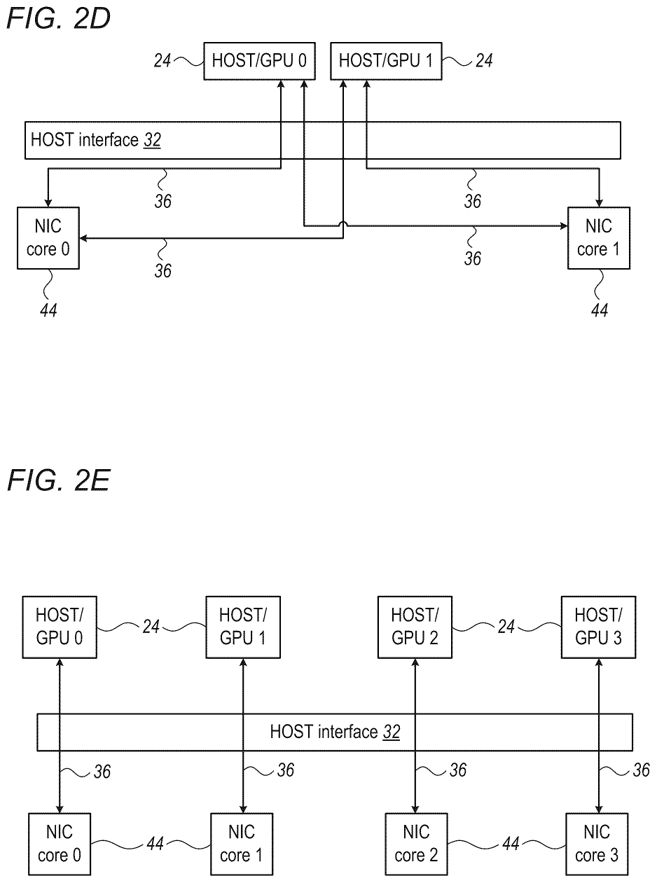

FIGS. 2A-2E are block diagrams that schematically illustrate example topologies for connecting one or more hosts 24 to multicore NIC 20, and specifically to NIC cores 44 within NIC 20, in accordance with embodiments that are described herein. A given topology is typically provisioned by configuring host interface 32.

In the embodiments described herein, each NIC core 44 is assigned one or more respective communication link 36 of host interface 32. In the non-limiting examples of FIGS. 2A-2E, each link 36 is a respective PCIe Physical Function (PF). A given PF 36 is assigned for communicating between a given NIC core 44 and a given host 24. Typically, a PF 36 is not shared by multiple NIC cores 44, and not by multiple hosts 24.

In FIG. 2A, the four NIC cores 44 (“NIC CORE 0”- “NIC CORE 3”) communicate with a single host 24 using four respective PFs 36. This host is in turn connected to two other hosts 24 (in the present example GPUs denoted “GPU0” and “GPU1”). All three hosts 24 are served by the four NIC cores 44.

In FIG. 2B, a first NIC core 44 (“NIC CORE 0”) communicates with two hosts 24 (“HOST/GPU 0” and “HOST/GPU 1”) using two respective PCIe PFs 36. A second NIC core 44 (“NIC CORE 1”) communicates with two additional hosts 24 (“HOST/GPU 2” and “HOST/GPU 3”) using two additional respective PCIe PFs 36.

In FIG. 2C, two NIC cores 44 (“NIC CORE 0” and “NIC CORE 0”) communicate with a host 24 (“HOST/GPU 0”) using a PF 36. Two additional NIC cores 44 (“NIC CORE 2” and “NIC CORE 3”) communicate with an additional host 24 (“HOST/GPU 1”) using another PF 36.

In FIG. 2D, two NIC cores 44 (“NIC CORE 0” and “NIC CORE 1”) communicate with two hosts 24 (“HOST/GPU 0” and “HOST/GPU 1”) such that both NIC cores serve both hosts. One PF 36 is used for connecting “NIC CORE 0” to “HOST/GPU 0”; a second PF 36 is used for connecting “NIC CORE 0” to “HOST/GPU 1”; a third PF 36 is used for connecting “NIC CORE 1” to “HOST/GPU 0”; and a fourth PF 36 is used for connecting “NIC CORE 1” to “HOST/GPU 1”.

In FIG. 2E, four NIC cores 44 (“NIC CORE 0”-“NIC CORE 3”) communicate with four respective hosts 24 (“HOST/GPU 0”-“HOST/GPU 3”) using four respective PCIe PFs 36. Each NIC core 44 is assigned to serve a respective host 24.

The five topologies shown in FIGS. 2A-2E are in no way intended to be an exhaustive list of all possible topologies, but to provide examples that demonstrate the flexibility of the host interface. Host interface 32 can be configured to provide any other suitable topology in alternative embodiments. In an embodiment, the controller of NIC 20 (e.g., “NIC CORE 0”) configures host interface 32 to provide the desired topology.

### Packet Transmission Processing

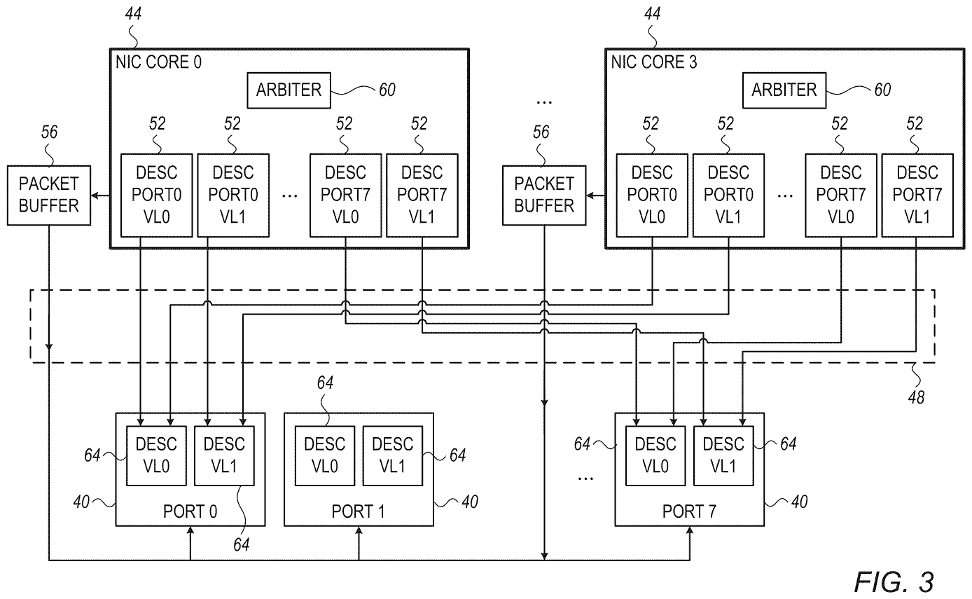

FIG. 3 is a block diagram that schematically illustrates the process of packet transmission in multicore NIC 20, in accordance with an embodiment that is described herein. The figure focuses on elements of NIC cores 44 and ports 40 that are relevant to packet transmission from NIC 20 to network 28.

In the embodiment of FIG. 3, each NIC core 44 comprises multiple core-side descriptor queues 52. Each core-side descriptor queue 52 corresponds to (i) a port number identifying a certain port 40, and (ii) a Virtual Lane (VL) index identifying a certain Quality-of-Service (QoS) class. In other words, each core-side descriptor queue 52 is assigned to queue descriptors of packets that (i) are destined for transmission via a given port 40, and (ii) are associated with a VL.

Each NIC core 44 is also associated with a respective memory region referred to as a packet buffer 56, for storing packets that are pending for transmission. Each NIC core 44 further comprises an arbiter 60 that, for each packet pending for transmission, selects a port via which the packet will be transmitted.

In the present example, each port 40 comprises multiple port-side descriptor queues 64. Each port-side descriptor queue 64 corresponds to a certain VL, i.e., assigned to queue the descriptors of packets that are pending for transmission via the port and have this VL (QoS) class.

Arrows in the figure represent transfer of information (e.g., packet descriptors and packet data) from NIC cores 44 to ports 40 via crossbar 48. As seen, any port 40 can receive packets for transmission from any NIC core 44.

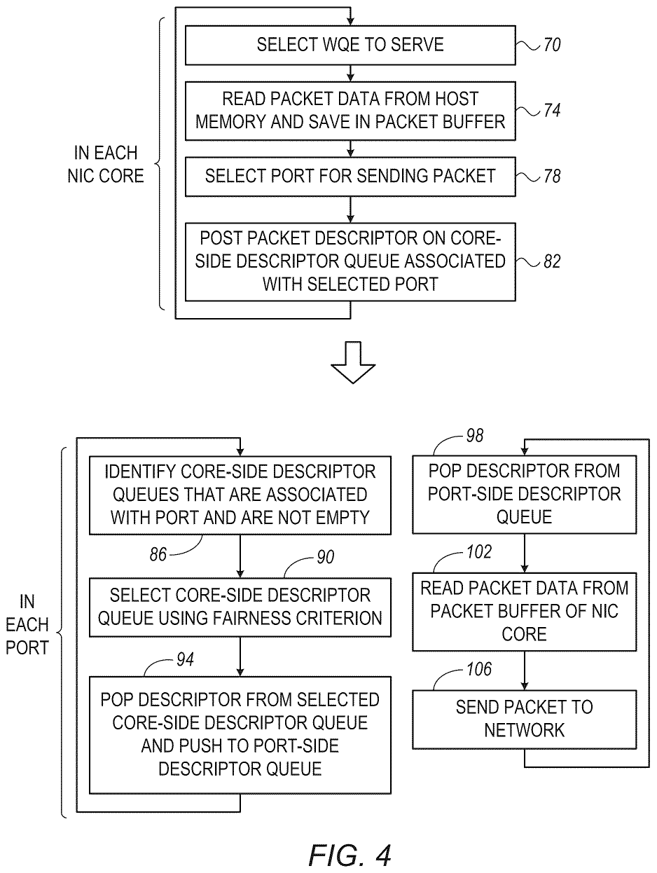

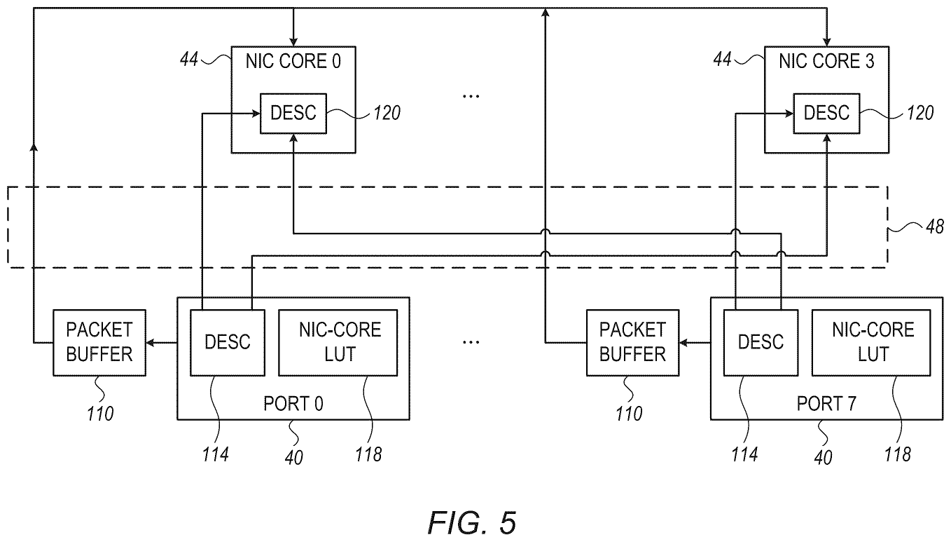

FIG. 4 is a flow chart that schematically illustrates a method for packet transmission in multicore NIC 20, in accordance with an embodiment that is described herein. The method is best understood by referring jointly to FIGS. 3 and 4.

### Nic-Core-Side Transmission Processing

Stages 70-82 of FIG. 4 are performed by each NIC core 44. To transmit a packet via a certain NIC core 44, a host 24 typically posts a descriptor of the packet, referred to as a Work Queue Element (WQE), on a queue that is accessible to the NIC core. The packet transmission process begins with NIC core 44 selecting a WQE to serve, at a WQE selection stage 70. At a packet readout stage 74, NIC core 44 reads the packet data from the host memory and saves the packet data (typically including both the packet header and the packet payload) in packet buffer 56.

At a port selection stage 78, arbiter 60 of NIC core 44 selects a port among ports 40 for transmitting the packet to network 28. In selecting the port, arbiter 60 typically uses a criterion that aims to balance the traffic load among ports 40. In an example embodiment, arbiter 60 checks (i) the status of port-side descriptor queues 64 of the various ports 40, and (ii) the congestion control states of the various ports 40. Based on this information, arbiter 60 selects the least occupied port. Alternatively, arbiter 60 of NIC core 44 may apply any other suitable load balancing scheme.

Having selected a port for the packet, and recognizing the VL assigned to the packet, NIC core 44 posts a descriptor of the packet on the core-side descriptor queue 52 of the selected port and VL, at a posting stage 82. The method then loops back to stage 70 above for generating the next packet.

The process of stages 70-82 is typically carried out in parallel by the various NIC cores 44 of NIC 20. Thus, at any given time, core-side descriptor queues 52 of the various NIC cores 44 queue the descriptors of the packets pending for transmission. Packet buffers 56 hold the corresponding packets.

### Port-Side Transmission Processing

Stages 86-106 of FIG. 4 are performed by each port 40. The port-side part of the transmission process comprises two sub-processes that are performed in parallel. At stages 86-94 (left-hand side), port 40 fetches descriptors of pending packets from the various NIC cores 44, while maintaining fairness in serving the NIC cores. At stages 98-106 (right-hand side), port 40 transmits the corresponding packets to network 28.

The sub-process of fetching descriptors of pending packets from NIC cores 44 comprises the following:
At a pending queue identification stage 86, port 40 identifies a subset of core-side descriptor queues 52 that are (i) assigned to the port, and (ii) non-empty. These core-side descriptor queues 52 are the candidates from which the port will select the next packet for transmission.
At a queue selection stage 90, the port selects one of the core-side descriptor queues 52 in the identified subset (of non-empty queues that are associated with this port and that have pending descriptors). In selecting the queue, port 40 typically applies a selection criterion that aims to maintain fairness among the multiple NIC cores 44. In some embodiments, the selection criterion gives precedence to queues of higher-priority VLs (higher QoS classes) over queues of lower VLs (lower QoS classes), while maintaining fairness.
At a descriptor transfer stage 94, port 40 pops the packet descriptor from the head of the selected core-side queue 52, and posts the descriptor to port-side queue 64 of the port.

The sub-process of transmitting the packets to network comprises the following (per VL):
At a descriptor popping stage 98, port 40 pops the next packet descriptor from the head of the port-side descriptor queue.
At a packet readout stage 102, port 40 reads the packet data (header and payload) of the corresponding packet from packet buffer 56 of the NIC core 44 that generated the packet.
At a transmission stage 106, port 40 sends the packet to network 28.

The method flow depicted in FIG. 4 is an example flow that is chosen purely for the sake of conceptual clarity. In alternative embodiments, any other suitable flow can be used.

### Packet Reception Processing

FIG. 5 is a block diagram that schematically illustrates packet reception in multicore NIC 20, in accordance with an embodiment that is described herein. The figure focuses on elements of NIC cores 44 and ports 40 that are relevant to packet reception from network 28.

In the embodiment of FIG. 5, each port 40 comprises a port-side descriptor queue 114 (not to be confused with port-side descriptor queues 64 of FIG. 3), and each NIC core 44 comprises a core-side descriptor queue 120 (not to be confused with core-side descriptor queues 52 of FIG. 3). Port-side descriptor queue 114 of a given port 40 is used for storing descriptors of packets that are received by the port from network 28. Core-side descriptor queue 120 of a given NIC core 44 is used for storing descriptors of packets that were received by ports 40 and forwarded to the NIC core from the ports.

In disclosed embodiments, the identity of the NIC core 44 (from among the multiple NIC cores 44) that is designated to process a given received packet is derived from the destination address specified in the packet. In some embodiments, the destination address in question is an Internet Protocol (IP) address specified in the received packet. In other embodiments, the destination address is a Medium Access Control (MAC) address specified in the packet. Other suitable types of destination addresses can also be used. In alternative embodiments, port 40 may derive the identity of the NIC core 44 that is designated to process a given received packet from any other suitable value specified in the header of the received packet.

In the embodiment of FIG. 5, each port 40 comprises a NIC-core Look-Up Table (LUT) 118 that stores a mapping between destination addresses and NIC cores. LUT 118 typically comprises multiple entries. Each entry specifies (i) a destination address or a range of destination addresses, and (ii) an identifier of the NIC core 44 that is designated to process received packets having this destination address (or whose destination address falls in the specified range).

Port 40 uses the mapping in LUT 118 to determine which NIC core 44 is to process a given received packet. In an embodiment, the controller of NIC 20 (e.g., “NIC CORE 0”) configures LUTs 118 of ports 40 with the mapping. The mapping between destination addresses and NIC cores is typically the same for all ports 40. In some embodiments, LUTs 118 of different ports 40 may store different subsets of the mapping, as needed.

In addition, each port 40 is associated with a respective memory region referred to as a packet buffer 110, for storing packets that have been received from network 28 and are pending for transfer to NIC cores 44.

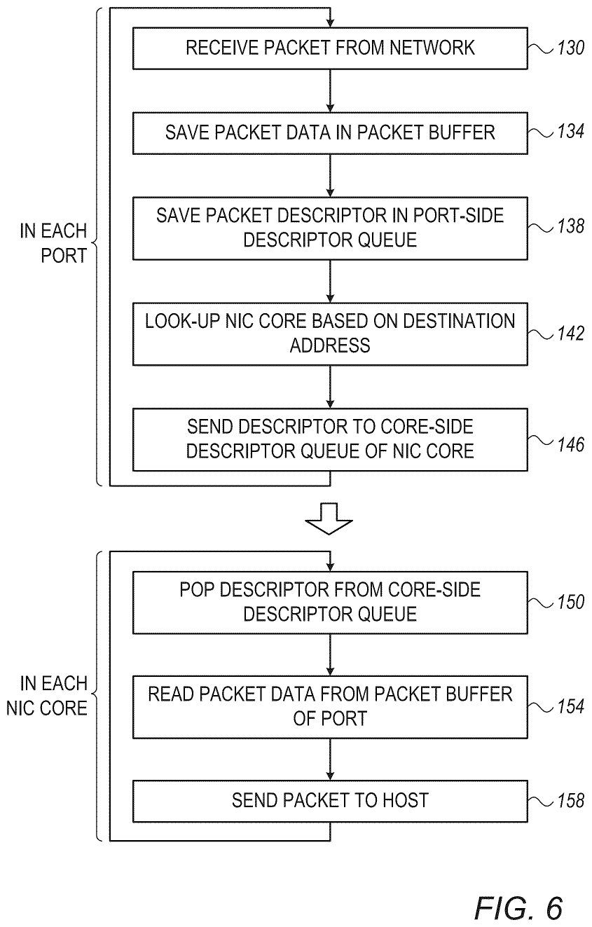

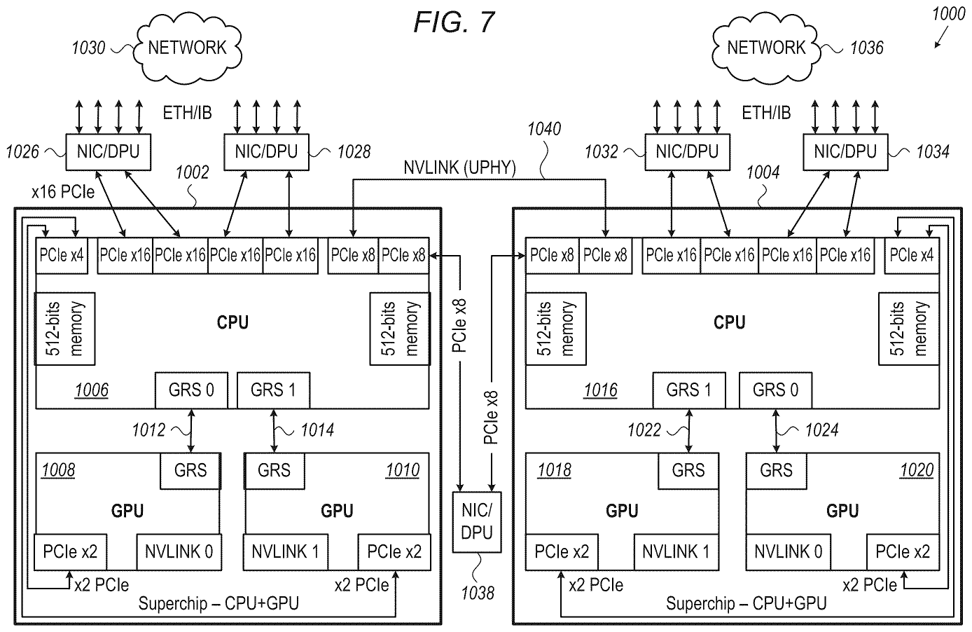

FIG. 6 is a flow chart that schematically illustrates a method for packet reception in multicore NIC 20, in accordance with an embodiment that is described herein. The method is best understood by referring jointly to FIGS. 5 and 6.

### Port-Side Reception Processing

Stages 130-146 of FIG. 6 are performed by each port 40. The packet reception process begins with port 40 receiving a packet from network 28, at a reception stage 130. At a packet saving stage 134, port 40 saves the packet data (header and payload) in packet buffer 110 of the port. At a descriptor saving stage 138, port 40 generates a packet descriptor for the received packet, and posts the packet descriptor on port-side descriptor queue 114 of the port.

At a core selection stage 142, port 40 queries LUT 118 with the destination address of the received packet. LUT 118 returns the identifier of the NIC core 44 that should process the packet. At a descriptor transfer stage 146, port 40 transfers the packet descriptor of the packet from port-side descriptor queue 114 to core-side descriptor queue 120 of the selected NIC core 44.

### Core-Side Transmission Processing

Stages 150-158 of FIG. 6 are performed by each NIC core 44. The core-side part of the reception process begins with NIC core 44 popping the next descriptor from the head of core-side descriptor queue 120, at a descriptor popping stage 150. At a packet readout stage 154, NIC core 44 reads the packet data (header and payload) from packet buffer 110 of the port from which the packet was forwarded. At a host sending stage 158, NIC core 44 sends the packet to the destination host.

The configurations of multicore NIC 20 and its various components, as shown in FIGS. 1, 2A-2E, 3 and 5, are example configurations that are chosen purely for the sake of conceptual clarity. In alternative embodiments, any other suitable configurations can be used.

The method flow depicted in FIG. 6 is an example flow that is chosen purely for the sake of conceptual clarity. In alternative embodiments, any other suitable flow can be used.

### EXAMPLE SYSTEM USE-CASE

FIG. 3 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036.

The coupling of processing devices through NVLink allows for seamless data exchange and parallel processing, enhancing overall computational performance. The processing devices are connected to multiple networks through one or more NICs or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 3 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 3, CPU 1006 is coupled to a first NIC/DPU 1026, which is coupled to a network 1030. CPU 1006 is also coupled to a second NIC/DPU 1028, which is coupled to network 1030. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 3, CPU 1016 is coupled to a first NIC/DPU 1032, which is coupled to a network 1036. CPU 1016 is also coupled to a second NIC/DPU 1034, which is coupled to network 1036. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

In various embodiments, any of NICs/DPUs 1026, 1028, 1032, 1034 and 1038 in system 1000 may comprise a multicore NIC as described herein.

The various elements of multicore NIC 20 and its various components may be implemented in hardware, e.g., in one or more Application-Specific Integrated Circuits (ASICs) or FPGAs, in software, or using a combination of hardware and software elements. In some embodiments, certain elements of multicore NIC 20, e.g., the controller of NIC 20 or elements of NIC cores 44, may be implemented, in part or in full, using one or more general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory. Elements that are not necessary for understanding the principles of the disclosed solution have been omitted from the figures for clarity.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A network adapter, comprising:
a host interface, to communicate with one or more hosts;
multiple port circuits, to communicate with a packet network;
a plurality of network-adapter cores, to serve the one or more hosts in transmitting and receiving packets over the packet network, while identifying to the one or more hosts as respective independent network adapters; and
a crossbar circuit, to connect the network-adapter cores to the port circuits.

2. The network adapter according to claim 1, wherein a network-adapter core is to select a port circuit for transmitting a packet to the network by applying a criterion aiming to balance a traffic load among the multiple port circuits.

3. The network adapter according to claim 1, wherein:
two or more of the network-adapter cores are to queue packet descriptors, of packets that are destined to a port circuit, in respective queues associated with the port circuit; and
the port circuit is to pop the packet descriptors from the queues of the network-adapter cores in accordance with a scheduling criterion, and to send the corresponding packets to the packet network.

4. The network adapter according to claim 3, wherein the scheduling criterion aims to apply fairness among a subset of the queues of the network-adapter cores that are non-empty.

5. The network adapter according to claim 1, wherein a port circuit is to receive packets from the packet network and, for each packet, to determine a network-adapter core that will process the packet, and to send the packet to the determined network-adapter core.

6. The network adapter according to claim 5, wherein the port circuit is to determine the network-adapter core depending on a destination address specified in the packet.

7. The network adapter according to claim 5, wherein the port circuit is to determine the network-adapter core based on a value specified in the packet header.

8. The network adapter according to claim 1, wherein the host interface is to communicate with the one or more hosts over a peripheral bus, and is configurable to set-up multiple links of the peripheral bus, connecting each network-adapter core to one or more of the hosts.

9. The network adapter according to claim 8, wherein the host interface is to assign each of the network-adapter cores one or more unique physical functions of the peripheral bus.

10. The network adapter according to claim 1, wherein:
any of the network-adapter cores is to communicate packets with any of the port circuits;
any of the port circuits is to communicate packets with any of the network-adapter cores; and
the crossbar circuit is to connect any of the network-adapter cores with any of the port circuits.

11. A method in a network adapter that includes a host interface, multiple port circuits, a plurality of network-adapter cores and a crossbar circuit, the method comprising:
communicating with one or more hosts using the host interface;
communicating with a packet network using the multiple port circuits;
connecting the network-adapter cores to the port circuits using the crossbar circuit; and
using the plurality of network-adapter cores of the network adapter, serving the one or more hosts in transmitting and receiving packets over the packet network, while identifying to the one or more hosts as respective independent network adapters.

12. The method according to claim 11, wherein serving the hosts comprises, in a network-adapter core, selecting a port circuit for transmitting a packet to the network by applying a criterion aiming to balance a traffic load among the multiple port circuits.

13. The method according to claim 11, and comprising:
in two or more of the network-adapter cores, queuing packet descriptors, of packets that are destined to a port circuit, in respective queues associated with the port circuit; and
popping the packet descriptors from the queues of the network-adapter cores, by the port circuit, in accordance with a scheduling criterion, and sending the corresponding packets from the port circuit to the packet network.

14. The method according to claim 13, wherein the scheduling criterion aims to apply fairness among a subset of the queues of the network-adapter cores that are non-empty.

15. The method according to claim 11, and comprising, in a port circuit, receiving packets from the packet network and, for each packet, determining a network-adapter core that will process the packet, and sending to the packet to the determined network-adapter core.

16. The method according to claim 15, wherein determining the network-adapter core comprises determining the network-adapter core depending on a destination address specified in the packet.

17. The method according to claim 15, wherein determining the network-adapter core comprises determining the network-adapter core based on a value specified in the packet header.

18. The method according to claim 11, wherein communicating with the one or more hosts is performed over a peripheral bus, including configuring the host interface to set-up multiple links of the peripheral bus to connect each network-adapter core to one or more of the hosts.

19. The method according to claim 18, wherein configuring the host interface comprises assigning each of the network-adapter cores one or more unique physical functions of the peripheral bus.

20. The method according to claim 11, wherein:
communicating packets between any of the network-adapter cores and any of the port circuits;
communicating packets between any of the port circuits and any of the network-adapter cores; and
using the crossbar circuit connecting any of the network-adapter cores with any of the port circuits.
